(19) United States
(12) Patent Application Publication
(10) Pub. No.: US 2025/0296883 A1
(43) Pub. Date: Sep. 25, 2025

(54) COMPOSITE PARTICLES AND METHOD FOR PRODUCING SAME

(71) Applicant: TOHOKU UNIVERSITY, Sendai-shi, Miyagi (JP)

(72) Inventors: Naoyuki NOMURA, Sendai-shi (JP); Weiwei ZHOU, Sendai-shi (JP); Mingqi DONG, Sendai-shi (JP)

(21) Appl. No.: 18/863,073

(22) PCT Filed: Sep. 5, 2022
(86) PCT No.: PCT/JP2022/033276

§ 371 Date: Nov. 5, 2024

(30) Foreign Application Priority Data
May 9, 2022 (WO) PCT/JP2022/019729

(51) Int. Cl. C04B 35/117; B22F 1/05; B22F 1/065; B22F 1/16; B33Y 70/10; C04B 35/488; C04B 35/628; C22C 14/00

(52) U.S. Cl. CPC C04B 35/117; B22F 1/05; B22F 1/065; B22F 1/16; B33Y 70/10; C04B 35/488; C04B 35/62813; C04B 35/62823; C22C 14/00; B22F 2301/205; B22F 2302/25; B22F 2302/253; B22F 2304/10; B22F 2999/00; C04B 2235/3217; C04B 2235/3244; C04B 2235/404; C04B 2235/528; C04B 2235/5436; C04B 2235/5445; C04B 2235/5454

(57) ABSTRACT

A method for producing composite particles, the method including mixing first particles that are positively charged in water and second particles that are positively charged in water and have an average particle size smaller than that of the first particles in an aqueous medium in the presence of ultrafine bubbles, thereby depositing the second particles on surfaces of the first particles to produce composite particles.

### CROSS-REFERENCE TO RELATED APPLICATIONS

This application is the U.S. National Stage entry of International Application No. PCT/JP2022/033276, filed on Sep. 5, 2022, which, in turn, claims priority to International Patent Application No. PCT/JP2022/019729, filed on May 9, 2022, both of which are hereby incorporated herein by reference in their entireties for all purposes.

### TECHNICAL FIELD

The present invention relates to composite particles and a method for producing the composite particles.

### BACKGROUND ART

Metal particles having a particle size in the order of micrometers (μm) are used as modeling materials for 3D printers. A 3D printer irradiates metal particles with a laser or an electron beam, thereby causing the metal particles to temporarily melt and solidify in a desired shape to create a model.

It is effective to modify the surface states of the metal particles to improve the absorption efficiency of the laser beam and the electron beam in order to reduce the amount of energy during melting the metal particles in 3D printers. Examples of the conceivable method to modify the surface states of the metal particles include a method in which the surfaces of the metal particles are coated with inorganic fine particles having a particle size on the order of nanometers (nm) to increase the surface area. As the inorganic fine particles, conceivable examples to be used include oxide fine particles having a melting temperature higher than that of the metal particles. However, the metal particles become positively charged in water and the oxide fine particles also become positively charged in water. Therefore, when the metal particles and the oxide fine particles are mixed in water, both particles repel each other. Accordingly, the surfaces of the metal particles in water are difficult to be evenly coated with the oxide fine particles.

Examples of known method for producing composite particles with nanometer (nm)-size fine particles deposited on the surface of micrometer (μm)-size particles include a method in which after adjusting the surface charges of parent particles (micrometer (μm)-size particles) and of child particles (nanometer (nm)-size fine particles), the parent particle and the child particle are mixed in a liquid, thereby combining both particles through electrostatic attraction to create a composition thereof (Patent Document 1). As a method to adjust the surface charges of the parent particles and of the child particles, Patent Document 1 describes a method of causing parent particles and child particles to adsorb polyelectrolytes.

### CITATION LIST

### Patent Document

Patent Document 1: WO 2017/099250 A

### SUMMARY OF INVENTION

### Technical Problem

The particles to be used as a modeling material for 3D printers desirably do not generate foreign substances during irradiation with laser beam or the like. Accordingly, in the production of composite particle, it is desirable to use fewer chemical agent, such as a polyelectrolyte, for adjusting the surface charge.

The present invention has been made in view of the circumstances described above, and an object of the present invention is to provide a method for producing composite particles in which nanometer (nm)-size fine particles can be deposited on the surfaces of micrometer (μm)-size particles without using an agent such as a polyelectrolyte for adjusting the surface charge, and composite particles with less deposition of an agent for adjusting the surface charge.

### Solution to Problem

The present inventors have found that, by mixing first particles that are positively charged in water and second particles that are positively charged in water and have an average particle size smaller than that of the first particles in an aqueous medium in the presence of ultrafine bubbles, the second particles can be deposited on the surfaces of the first particles without using an agent, such as a polyelectrolyte, for adjusting the surface charge, and thus the present invention has been completed.

Accordingly, the present invention has the following aspects.

[1] A method for producing composite particles, the method including mixing first particles that are positively charged in water and second particles that are positively charged in water and have an average particle size smaller than that of the first particles in an aqueous medium in the presence of ultrafine bubbles, thereby depositing the second particles on surfaces of the first particles to produce composite particles.

[2] The method for producing composite particles according to [1], wherein a ratio of the average particle size of the second particles to the average particle size of the first particles is within a range of 1/10000 or more and 1/10 or less.

[3] The method for producing composite particles according to [1] or [2], wherein the average particle size of the first particles is within a range of 1 μm or more and 1000 μm or less.

[4] The method for producing composite particles according to any one of [1] to [3], wherein the average particle size of the second particles is within a range of 1 nm or more and 500 nm or less.

[5] Composite particles produced by the production method described in any one of [1] to [4], wherein
the second particles are contained in an amount within a range of 0.2 mass % or more and 20 mass % or less based on a total mass of the composite particles, and
the first particles have a circularity within a range of 0.8 or more and 0.99 or less.

[6] The composite particles according to [5], wherein
the second particles are contained in an amount within a range of 0.2 mass % or more and 10 mass % or less based on the total mass of the composite particles.

[7] The composite particles according to [5] or [6], wherein
the circularity of the first particles is within a range of 0.85 or more and 0.99 or less.

[8] The composite particles according to [5], wherein
the first particles are made of a titanium-aluminum-vanadium alloy, and
the second particles are made of alumina or zirconia.

### Advantageous Effects of Invention

The present invention can provide a method for producing composite particles in which nanometer (nm)-size fine particles can be deposited on the surfaces of micrometer (μm)-size particles without using an agent, such as a polyelectrolyte, for adjusting the surface charge, and composite particles with small deposit of an agent for adjusting the surface charge.

### BRIEF DESCRIPTION OF DRAWINGS

FIG. 1 is a conceptual diagram of a method for producing a composite particle according to an embodiment of the present invention.

FIG. 2 is an SEM image of a dry powder obtained in Example 1.

FIG. 3 is an SEM image of a dry powder obtained in Example 2.

FIG. 4 is an SEM image of a dry powder obtained in Example 3.

FIG. 5 is an SEM image of a Ti6Al4V powder used in Examples 1 to 3.

FIG. 6 is a STEM image of an L-PBF production part obtained by using the composite particles obtained in Example 3.

FIG. 7 shows a HRTEM close-up image and a SAED pattern of an L-PBF production part obtained by using the composite particles obtained in Example 3.

FIG. 8 is the load versus indentation depth curves of an L-PBF production part obtained by using the composite particles obtained in Example 3.

FIG. 9 is the load versus indentation depth curves of an L-PBF production part obtained by using a Ti6Al4V powder used in Examples 1 to 3.

FIG. 10(a) is a plan view of a powder bed quality evaluation apparatus for additive manufacturing used in an adhesion evaluation test in Example 5, and FIG. 10(b) is a cross-sectional view taken along line b-b in FIG. 10(a).

FIG. 11(a) is an SEM image of a zirconia/Ti6Al4V composite particle before an adhesion evaluation test performed in Example 5, and FIG. 11(b) is an enlarged SEM image thereof.

FIG. 12(a) is an SEM image of a zirconia/Ti6Al4V composite particle after the adhesion evaluation test performed for the first time in Example 5, and FIG. 12(b) is an enlarged SEM image thereof.

FIG. 13(a) is an SEM image of a zirconia/Ti6Al4V composite particle after the adhesion evaluation test performed for the second time in Example 5, and FIG. 13(b) is an enlarged SEM image thereof.

FIG. 14(a) is an SEM image of a zirconia/Ti6Al4V composite particle after the adhesion evaluation test performed for the third time in Example 5, and FIG. 14(b) is an enlarged SEM image thereof.

FIG. 15(a) is an SEM image of a zirconia/Ti6Al4V composite particle after the adhesion evaluation test performed for the fourth time in Example 5, and FIG. 15(b) is an enlarged SEM image thereof.

FIG. 16(a) is an SEM image of a zirconia/Ti6Al4V composite particle after the adhesion evaluation test performed for the fifth time in Example 5, and FIG. 16(b) is an enlarged SEM image thereof.

FIG. 17 is a nominal stress-nominal strain plot obtained in a tensile test in which the zirconia/Ti6Al4V composite particles obtained in Example 6 are used.

FIG. 18 is a nominal stress-nominal strain plot obtained in a tensile test in which Ti6Al4V free particles are used as a reference example.

### DESCRIPTION OF EMBODIMENT

Hereinafter, the present embodiments will be described in detail with appropriate reference to the drawings. In the drawings used in the following description, for the sake of better understanding of the features of the present invention, the featured parts are illustrated enlarged in some cases as a matter of convenience, and the dimensional ratios and the like of components may differ from those of the actual ones. Materials, dimensions, and the like exemplified in the following description are just an example, and the present invention is not limited thereto, and can be appropriately modified and implemented without departing from the spirit of the present invention.

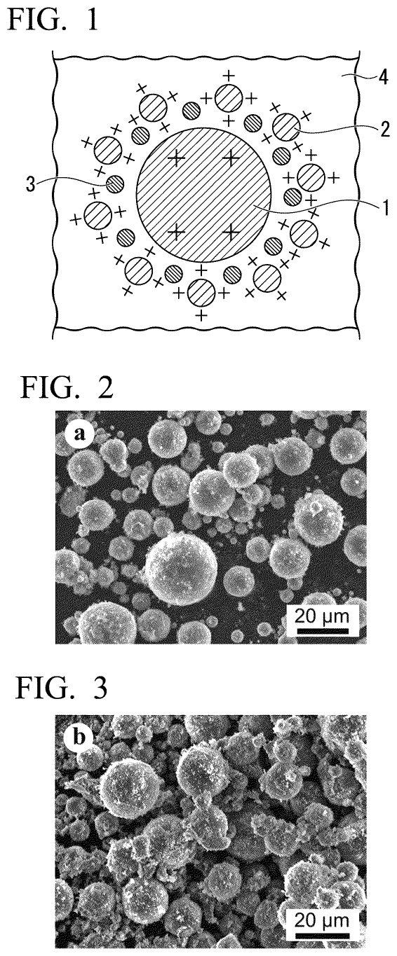

FIG. 1 is a conceptual diagram of a method for producing a composite particle according to an embodiment of the present invention.

As illustrated in FIG. 1, in the method for producing composite particles of the present embodiment, first particles 1 and second particles 2 are mixed in an ultrafine bubble-containing dispersion liquid 4 containing ultrafine bubbles 3. The ultrafine bubble-containing dispersion liquid 4 can be prepared by using, for example, a method of mixing a mixed aqueous dispersion liquid in which the first particles 1 and the second particles 2 are dispersed therein with ultrafine bubble water containing the ultrafine bubbles 3, or a method of mixing a dispersion liquid of the first particles 1 containing the ultrafine bubbles 3 with a dispersion liquid of the second particles 2 containing the ultrafine bubbles 3.

The first particles 1 and the second particles 2 each are positively charged particles in water. In contrast, the ultrafine bubbles 3 are negatively charged in water. The first particles 1 and the second particles 2 dispersed in the ultrafine bubble-containing dispersion liquid 4 are electrically neutralized by the ultrafine bubbles 3. When the first particles 1 and the second particles 2 are electrically neutralized, the first particles 1 and the second particles 2 are attracted to each other by an intermolecular force. As a result, a large number of the second particles 2 are deposited on the surface of the first particle 1 to create a composite particle.

The first particles 1 have an average particle size, for example, within a range of 0.1 μm or more and 1000 μm or less. The lower limit of the average particle size of the first particles 1 is preferably 5 μm or more, and more preferably 10 μm or more. The upper limit of the average particle size of the first particles 1 is preferably 500 μm or less, and more preferably 100 μm or less. The second particles 2 have an average particle size, for example, within a range of 1 nm or more and 500 nm or less. The lower limit of the average particle size of the second particles 2 is preferably 5 nm or more, and more preferably 10 nm or more. The upper limit of the average particle size of the second particles 2 is preferably 300 nm or less, and more preferably 100 nm or less. The ratio of the average particle size of the second particles 2 to the average particle size of the first particles 1 is, for example, within a range of 1/10000 or more and 1/10 or less, preferably within a range of 1/5000 or more and 1/50 or less, and more preferably within a range of 1/2000 or more and 1/500 or less.

The average particle sizes of the first particles 1 and of the second particles 2 can be an average of particle sizes of 100 particles measured with a SEM (scanning electron microscope), for example.

The material of the first particles and the material of the second particles are not particularly limited. The material of the first particles 1 and the material of the second particles may be the same as or different from each other. As the materials of the first particles and of the second particles, examples thereof that can be used include metals, semimetals, oxides, hydroxides, carbonates, carbides, nitrides, and borides. Examples of the metal include Mg, Ca, Sr, Ba, Sc, Y, La, Ti, V, Cr, Mn, Fe, Co, Ni, Cu, Zr, Nb, Mo, Ru, Ag, W, Al, Zn, Ga, In, Sn, Pb, and Bi, and alloys of these metals. Examples of the semimetal include Si, Ge, and Sb. Examples of the oxide include magnesium oxide, calcium oxide, iron oxide, titanium oxide, zirconia, zinc oxide, alumina, and silicon oxide. Examples of the hydroxide include magnesium hydroxide, calcium hydroxide, and aluminum hydroxide. Examples of the carbonate include lithium carbonate, magnesium carbonate, calcium carbonate, and barium carbonate. Examples of the carbide include calcium carbide, silicon carbide, and titanium carbide. Examples of the nitride include silicon nitride and titanium nitride. Examples of the boride include iron boride and titanium boride. As an example of a preferable combination among these materials, mention may be made of a combination in which one material of the first particles 1 and the second particles 2 is an oxide (especially, magnesium oxide, alumina, zirconia oxide) and the other material of the first particles 1 and the second particles 2 is a metal (especially, Ti, Fe, Ni, Zr, Al). As an example, mention may be made of a combination in which the first particles 1 are made of a titanium-aluminum-vanadium alloy and the second particles are made of alumina or zirconia.

The ultrafine bubbles 3 are also referred to as nanobubbles, and mean fine bubbles having a volume equivalent diameter of less than 1 μm as defined in JIS B8741-1:2019 (Fine bubble technology—General principles for usage and measurement of fine bubbles—Part 1: Terminology). The ultrafine bubble water is a liquid through which diffused reflection of laser beam by the ultrafine bubbles 3 is observed when irradiated with laser beam. Note that, the ultrafine bubble-containing dispersion liquid 4 may contain fine bubbles (microbubbles).

The ultrafine bubble water is, for example, pure water in which ultrafine bubbles 3 are generated. Pure water is water containing no impurities, or high purity water in which impurities are very small even if contained. As the pure water, for example, pure water having an electric conductivity of 1 μS/cm or less can be used. The kind of gas forming the ultrafine bubbles 3 is not particularly limited, and for example, air, oxygen, nitrogen, ozone, and carbon dioxide can be used.

In the present embodiment, the first particles 1 and the second particles 2 are mixed in the ultrafine bubble-containing dispersion liquid 4 containing the ultrafine bubbles 3, thereby the second particles 2 can be deposited on the surfaces of the first particles 1 while the deformation of the first particles 1 being suppressed as compared with a case where the first particles 1 and the second particles 2 are merely mixed without using the ultrafine bubbles.

The ultrafine bubble-containing dispersion liquid 4 contains the first particles 1 in an amount, for example, within a range of 0.2 vol % or more and 1.5 vol % or less. The lower limit of the amount of the first particles 1 contained is preferably 0.3 vol % or more, and more preferably 0.5 vol % or more. The upper limit of the amount of the first particles 1 contained is preferably 1.2 vol % or less, and more preferably 1.0 vol % or less. The ultrafine bubble-containing dispersion liquid 4 contains the second particles 2 in an amount, for example, within a range of 0.02 vol % or more and 0.3 vol % or less. The lower limit of the amount of the second particles 2 contained is preferably 0.02 vol % or more, and more preferably 0.05 vol % or more. The upper limit of the amount of the second particles 2 contained is preferably 0.20 vol % or less, and more preferably 0.15 vol % or less. The mass ratio of the amount of the second particles 2 contained to the amount of the first particles 1 contained (second particle content/first particle content) is, for example, within a range of 1/1000 or more and 1/10 or less, preferably within a range of 1/500 or more and 1/50 or less, and more preferably within a range of 1/400 or more and 1/100 or less.

The ultrafine bubble-containing dispersion liquid 4 has a pH value, for example, within a range of 6 or greater and 8 or less. The ultrafine bubble-containing dispersion liquid 4 has a zeta potential, for example, within a range of −65 mV or higher and −10 mV or lower, and preferably within a range of −60 mV or higher and −10 mV or lower.

The composite particles produced in the ultrafine bubble-containing dispersion liquid 4 can be collected by using a solid-liquid separation method such as decantation or filtration. The collected composite particles usually undergo a drying process. As the drying process, for example, vacuum drying can be used.

Composite particles obtained by the method for producing composite particles of the present embodiment contain first particles 1 and a plurality of second particles 2 deposited on the surfaces of the first particles 1. The second particles 2 are contained in an amount within a range of 0.2 mass % or more and 20 mass % or less, preferably within a range of 0.2 mass % or more and 10 mass % or less, more preferably within a range of 0.2 mass % or more and 5 mass % or less, and still more preferably within a range of 0.3 mass % or more and 5 mass % or less based on the total mass of the composite particle.

The concentration of the second particles 2 contained can be calculated, for example, using the following equation.

Second particle content (mass %)=[(Oxygen content (mass %) in composite powder-Oxygen content (mass %) in first particle)/(Atomic mass of oxygen×2)]×Atomic mass of second particle

In the composite particles obtained by the method for producing composite particles of the present embodiment, the amount of the second particles 2 deposited on the first particles 1 can be adjusted, for example, so a mass ratio of the amount of the second particles 2 contained to the amount of the first particles 1 (second particle content/first particle content) as to be within a range of 1/1200 or more and 1/12 or less, preferably within a range of 1/1100 or more and 1/13 or less, and more preferably within a range of 1/1000 or more and 1/14 or less.

In the composite particles obtained by the method for producing composite particles of the present embodiment, the first particles 1 have a circularity within a range of 0.8 or more and 0.99 or less, preferably within a range of 0.85 or more and 0.99 or less, more preferably within a range of 0.85 or more and 0.95 or less, and particularly preferably within a range of 0.9 or more and 0.95 or less.

The circularity of the first particles 1 can be calculated, for example, by determining an average value of circularities calculated from particle areas and perimeters obtained by image analysis.

When the circularity of the first particles 1 before mixing is denoted by W1 and the circularity of the first particles 1 after mixing is denoted by W2, the absolute value of the difference between them (W1−W2) is preferably within a range of 0.1 or less, more preferably within a range of 0.05 or less, and still more preferably within a range of 0.03 or less. When the first particles 1 and the second particles 2 are merely mixed without using ultrafine bubbles as in a known method, the surface of the first particle 1 is deformed to some extent to have a recess at the time when the second particle 2 is deposited on the first particle 1, and the second particle 2 enters the recess. Therefore, the circularity W2 of the first particles 1 after mixing is lower than the circularity W1 of the first particles 1 before mixing. In contrast, when the first particles 1 and the second particles 2 are mixed by using ultrafine bubbles as in the present embodiment, because of the intermolecular force between the first particle 1 and the second particle 2, the second particles are deposited on the surface of the first particle 1 while the surface of the first particle 1 remains almost undeformed. Accordingly, a decrease in the circularity W2 of the first particles 1 after mixing can be suppressed.

Composite particles of high purity can be obtained, because any other components other than the first particles 1, the second particles 2, and the ultrafine bubbles 3 are not particularly needed in the ultrafine bubble-containing dispersion liquid 4 to be used for the production of the composite particles.

According to the method for producing composite particles of the present embodiment configured as described above, the first particles 1 and the second particles 2 are mixed in the presence of the ultrafine bubbles 3, and thereby composite particles in which the second particles 2 are deposited on the surfaces of the first particles 1 can be obtained.

In the method for producing composite particles of the present embodiment, when the ratio of the average particle size of the second particles 2 to the average particle size of the first particles 1 is within a range of 1/5000 or more and 1/10 or less, the second particles 2 become easier to be evenly deposited on the surfaces of the first particles 1.

When the average particle size of the first particles 1 is within a range of 1 μm or more and 1000 μm or less and the average particle size of the second particles 2 is within a range of 1 nm or more and 500 nm or less, the resultant composite particles can be used for various applications such as a modeling material for a laser 3D printer, a catalyst, and a ceramic raw material.

In the present embodiment, the composite particles are produced by using the method for producing composite particles of the present embodiment, and thus the second particles 2 are evenly deposited on the surface of the first particle and the purity of the composite particles is high. Accordingly, the composite particles can be used for various applications such as a modeling material for a laser 3D printer, a raw material for powder metallurgy, an optical device, a catalyst, and a ceramic raw material.

In a composite particle to be used as a modeling material for a laser 3D printer, for example, a metal particle to be used as a modeling material for a laser 3D printer is used as the first particle 1, and an oxide particle having high laser absorption efficiency is used as the second particle 2. This composite particle has an unevenness formed by the second particles 2 deposited on the surface of the first particle 1 as compared with the free first particle 1, and thus easily melts and solidifies upon irradiation with laser beam as compared with a single body of the first particle 1. As the first particle 1, examples that can be used include Ti6Al4V, MoTiAl, and NiAlCrMo. As the second particle 2, examples that can be used include alumina and zirconia.

In a composite particle to be used as a catalyst, for example, an inert and chemically stable particle is used as the first particle 1, and a particle having a catalytic action is used as the second particle 2. This composite particle has a catalytic action higher than that of the free second particle 2 because the second particles do not form an agglomerate, but are deposited on the surface of the first particles 1.

In a composite particle to be used as a ceramic raw material, for example, a particle containing a first element as a component of a ceramic intended to be produced is used as the first particle 1, and a particle containing a second element as a component in the ceramic intended to be produced is used as the second particle 2. In this composite particle, the second particles 2 are evenly deposited on the surfaces of the first particle 1, and thus a ceramic produced by using this composite particle will have a uniform composition.

### EXAMPLES

### Example 1

Into 95 parts by mass of ion-exchanged water was added 5 parts by mass of alumina powder (with a purity: 99.9 mass %, and an average particle size: 125 nm), and the mixture was stirred for 1 hour with a stirrer while being cooled in an ice-water bath, followed by ultrasonic dispersion treatment to prepare an aqueous dispersion with alumina particle concentration of 5 mass %. Similarly, 5 parts by mass of Ti6Al4V powder (with a purity: 99.5 mass %, D10: 5.72 μm, D50: 14.06 μm, D90: 22.25 μm) was added to 95 parts by mass of ion-exchanged water, and the mixture was stirred for 1 hour with a stirrer while being cooled in an ice-water bath, followed by ultrasonic dispersion treatment to prepare an aqueous dispersion with Ti6Al4V particle concentration of 5 mass %. The Ti6Al4V powder used was spherical particles produced by an atomization process.

The alumina particle aqueous dispersion and the Ti6Al4V particle dispersion were mixed at a mass ratio of 1:9, and the mixture was stirred for 1 hour with a stirrer while being cooled in an ice-water bath to give a mixed aqueous dispersion with a solid content concentration of 5 mass %. The mixed aqueous dispersion contains the alumina in an amount of 0.63 vol % and the Ti6Al4V in an amount of 0.56 vol %. While the resulting mixed aqueous dispersion being stirred with a stirrer, ultrafine bubble water (having a zeta potential: −20 mV, available from Nippon Tungsten Co., Ltd.) was added into the mixed aqueous dispersion by using a separating funnel. After completion of dropwise addition of the ultrafine bubble water, the zeta potential of the mixed aqueous dispersion was found to be −15 mV. Note that, the zeta potential of ultrafine bubble water was measured with a nanoparticle analyzer (SZ-100, available from HORIBA, Ltd.).

After completion of dropwise addition of the ultrafine bubble water, the stirrer was stopped, and the mixed aqueous dispersion was filtered to collect a solid content. The collected solid content was dried under vacuum at a temperature of 298K to afford a dry powder.

### Example 2

A dry powder was obtained in the same manner as in Example 1 except that the concentrations of alumina particles in the aqueous dispersion and the concentrations of Ti6Al4V particles in the aqueous dispersion were each changed to 10 mass %. The mixed aqueous dispersion contains the alumina in an amount of 1.2 vol % and a Ti6Al4V in an amount of 1.1 vol %.

### Example 3

A dry powder was obtained in the same manner as in Example 1 except that a zirconia powder (with a purity: 99.9 mass %, and an average particle size: 53 nm) was used in place of the alumina powder, and the concentrations of zirconia particles in the aqueous dispersion and the concentrations of Ti6Al4V particles in the aqueous dispersion were each changed to 10 mass %. The mixed aqueous dispersion contains the zirconia in an amount of 0.38 vol % and the Ti6Al4V in an amount of 1.1 vol %.

### [Evaluation]

### (1) Surface Shape of Particles

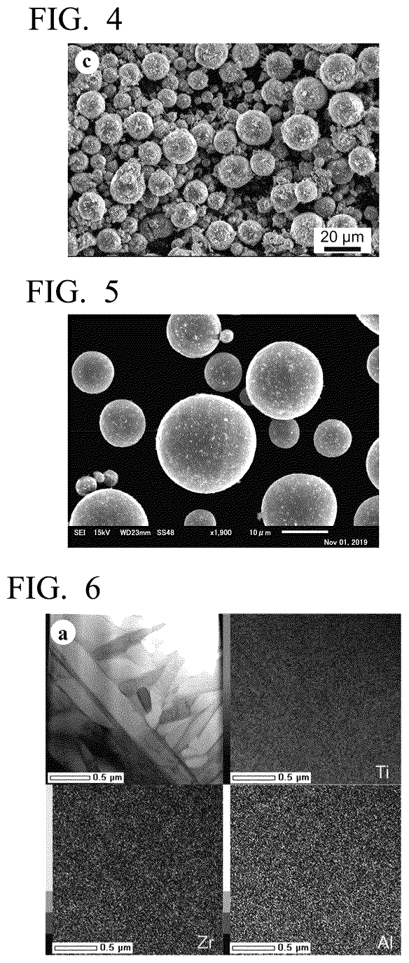

The particle surface of the dry powder each obtained in Examples 1 to 3 was observed with a scanning electron microscope. FIG. 2 shows a SEM image of the dry powder obtained in Example 1, FIG. 3 shows a SEM image of the dry powder obtained in Example 2, FIG. 4 shows a SEM image of the dry powder obtained in Example 3, and FIG. 5 shows a SEM image of the Ti6Al4V powder used in Examples 1 to 3.

It has been confirmed from the comparison between the SEM images of FIGS. 2 to 4 and the SEM image of FIG. 5 that composite particles in which alumina particles are deposited on the surfaces of Ti6Al4V particles have been produced in Examples 1 to 2, and composite particles in which zirconia particles are deposited on the surfaces of Ti6Al4V particles have been produced in Example 3.

### (2) Formability by Laser

The zirconia/Ti6Al4V composite particles obtained in Example 3 were melted and solidified by a laser powder bed fusion method (L-PBF) to afford an L-PBF production part. As a laser source, a Yb:YAG fiber laser source (Wuhan, available from Raycus Fiber Laser Technologies, laser wavelength: 1070 nm, maximum output: 22 W) was used. The irradiation with laser was performed in a high-purity argon gas atmosphere under the conditions of a laser power: 20.6 W, a scan speed: 10 mm·s⁻¹, a hatch distance: 100 μm, and a layer thickness: 25 μm. The melted zirconia/Ti6Al4V composite particles were solidified under a condition of condensation rate of 10³ to 10⁸K/s. The L-PBF production part was a rectangular parallelepiped having a width of 4 mm, a length of 4 mm, and a height of 1.4 mm.

The STEM image of the resultant L-PBF production part is shown in FIG. 6, and the HRTEM close-up image and the SAED pattern are shown in FIG. 7. It can be seen from the results of FIGS. 6 and 7 that the resultant L-PBF production part has a fine martensite structure because of a high solidification rate within a range from 10³ to 10⁸K/s. Incidentally, no ceramic phase was detected in the HRTEM close-up image shown in FIG. 7. This is thought to suggest that zirconia was decomposed by the irradiation with high-energy laser and dissolved in α′-Ti. It can be seen from the element distribution of FIG. 6 that zirconium is uniformly distributed in the structure without significant segregation because of the thermally dynamic and non-equilibrium properties of L-PBF.

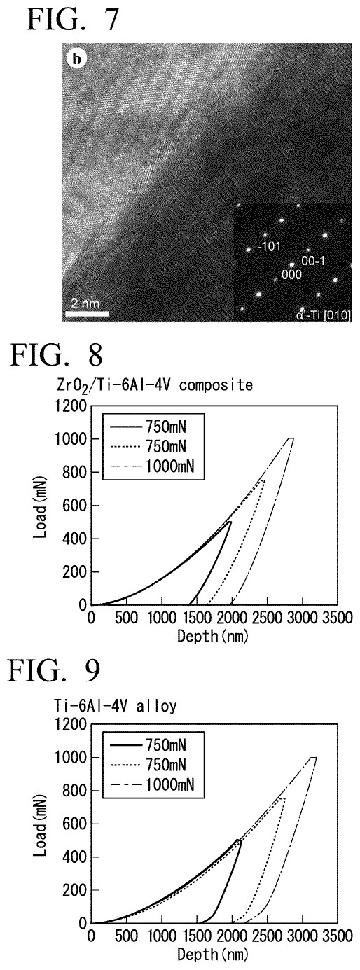

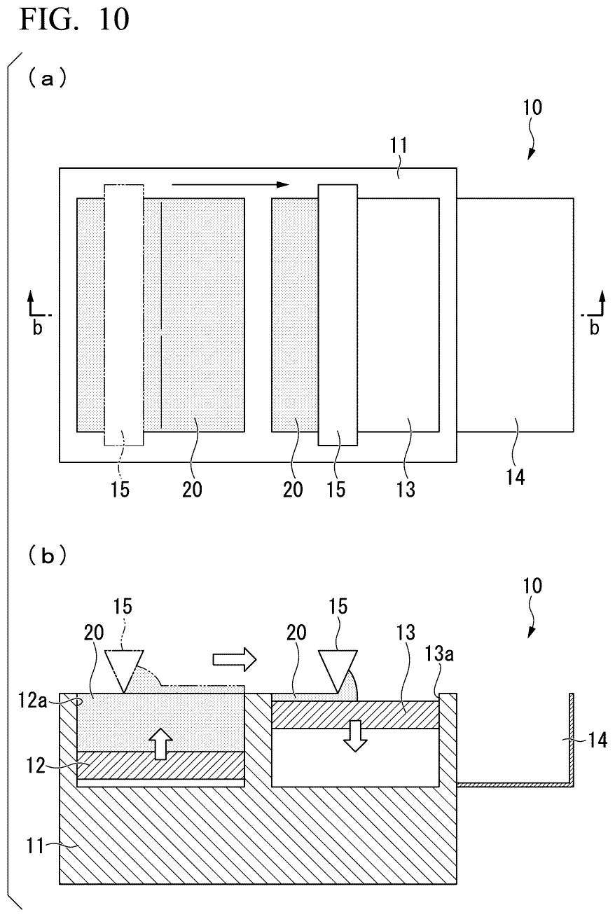

The mechanical strength of the L-PBF production part was measured by an indentation test. FIG. 8 is the load versus indentation depth curves of an L-PBF production part obtained by using zirconia/Ti6Al4V composite particles, and FIG. 9 is the load versus indentation depth curves of an L-PBF production part obtained by using Ti6Al4V particles.

It can be seen from the results in FIGS. 8 and 9 that the L-PBF production part obtained by using the zirconia/Ti6Al4V composite particles has a smaller indentation depth and higher rigidity than those of the L-PBF production part obtained by using the Ti6Al4V particles with the same load being applied.

The Vickers hardness of the L-PBF production part obtained by using the zirconia/Ti6Al4V composite particles and the Vickers hardness of the L-PBF production part obtained by using the Ti6Al4V particles were measured with a micro Vickers hardness testing machine (HM200, available from Mitutoyo Corporation). As a result, the Vickers hardness of the L-PBF production part obtained by using the zirconia/Ti6Al4V composite particles was found to be 714 HV, and the Vickers hardness was remarkably improved as compared with the Vickers hardness (519 HV) of the L-PBF production part obtained by using the Ti6Al4V composite particles.

It has been confirmed from the results set forth above that the zirconia/Ti6Al4V composite particles obtained in Example 3 are useful as a modeling material for a laser 3D printer.

### Example 4

Ultrafine bubble water and pure water were mixed in the amounts shown in Table 1 set forth below to prepare 500 mL of Nos. 1 to 5 aqueous media. The ultrafine bubble water used had a zeta potential of −47.1 mV, which was prepared by using pure water as raw material and under the condition of a bubbling time: 10 hours. The Ti6Al4V powder and the zirconia powder used were those used in Example 3.

Into 500 mL of each of Nos. 1 to 5 aqueous media were added 9 g of Ti6Al4V powder and 1 g of zirconia powder. The mixture was then mixed for 20 minutes with a stirrer to prepare a mixed aqueous dispersion. After completion of the stirring, the mixed aqueous dispersion was filtered to collect a solid content. The collected solid content was dried under vacuum at a temperature of 298K to afford a composite powder. The oxygen content (mass %) of the resultant composite powder was measured with an oxygen/nitrogen/hydrogen elemental analyzer (ONH836, available from LECO Corporation). From the obtained oxygen content and the premeasured oxygen content (0.2334 mass %) of the Ti6Al4V powder, the content of the zirconia powder in the composite powder was calculated by using the following equation.

zirconia powder content (mass %)=[(Oxygen content (mass %) in composite powder−Oxygen content (mass %) in Ti6Al4V powder)/(Atomic mass of oxygen×2)]×Atomic mass of ZrO₂

Table 1 shows the oxygen amount, the amount of oxygen increased, and the zirconia powder content of the composite powder. Note that the amount of oxygen increased is the oxygen content obtained by subtracting the oxygen content in the Ti6Al4V powder from the oxygen content in the composite powder.

TABLE 1

| | Composition of aqueous medium | | | | Composition of composite powder | | |
|---|---|---|---|---|---|---|---|
| | Amount of | Amount | | | | Amount of | Zirconium |
| | ultrafine | of pure | Total | Concentration | Oxygen | oxygen | oxide powder |
| | bubble water | water | amount | (%) of ultrafine | content | increased | content |
| No. | (mL) | (mL) | (mL) | bubble water | (mass %) | (mass %) | (mass %) |
| 1 | 100 | 400 | 500 | 20 | 2.0150 | 1.7816 | 6.8603 |
| 2 | 200 | 300 | 500 | 40 | 2.1300 | 1.8966 | 7.3031 |
| 3 | 300 | 200 | 500 | 60 | 2.3140 | 2.0806 | 8.0116 |
| 4 | 400 | 100 | 500 | 80 | 2.3498 | 2.1164 | 8.1495 |
| 5 | 500 | 0 | 500 | 100 | 2.3696 | 2.1362 | 8.2255 |

It can be seen from the results in Table 1 that a larger amount of the ultrafine bubble water in the aqueous medium increases the zirconia powder content of the composite powder. This is because a larger amount of the ultrafine bubble water increases the amount of nanometer (nm)-size zirconia deposited on the surfaces of the micrometer (μm)-size Ti6Al4V powder, and reduces the amount of zirconia discharged to the outside at the time when the mixed aqueous dispersion after completion of stirring is filtered.

### Example 5

Except that the zirconia particle aqueous dispersion and the Ti6Al4V particle aqueous dispersion were mixed at a mass ratio of 5:95, the same procedure as in Example 3 was carried out to produce 100 g of zirconia/Ti6Al4V composite particles. An evaluation test of adhesion between the zirconia particles and the Ti6Al4V composite particles in the resultant zirconia/Ti6Al4V composite particles was carried out with a powder bed quality evaluation apparatus for additive manufacturing (PBQ-3, manufactured by TOEI SCIENTIFIC INDUSTRY CO., LTD.).

FIG. 10(a) is a plan view of a powder bed quality evaluation apparatus for additive manufacturing used in an adhesion evaluation test, and FIG. 10(b) is a cross-sectional view taken along line b-b of FIG. 10(a). The powder bed quality evaluation apparatus for additive manufacturing 10 includes an apparatus main body 11, a particle feed platform 12, a build platform 13, an overflow-particle collection cup 14, and a wiper blade 15.

The particle feed platform 12 and the build platform 13 are disposed adjacent to each other on the surface of the apparatus main body 11. The overflow-particle collection cup 14 is disposed at a position opposite to the particle feed platform 12 with respect to the build platform 13.

The particle feed platform 12 and the build platform 13 each have a quadrangular shape in plan view. The particle feed platform 12 and the build platform 13 are configured to be movable in the vertical direction. The build platform 13 is a flat plate made of nickel-plated steel (surface roughness Ra: 3.87 μm). The wiper blade 15 is configured to be movable along the surface of the apparatus main body 11 from the particle feed platform 12 until the overflow-particle collection cup 14. The wiper blade 15 is a wiper blade for a laser additive manufacturing apparatus (available from Concept Laser GmbH, Y-shape lip 120 mm).

The adhesion evaluation test is carried out as follows.

(1) The particle feed platform 12 is moved downward to create a gap 12a between the particle feed platform 12 and the apparatus main body 11.

(2) A sample 20 (zirconia/Ti6Al4V composite particles) is filled into the gap 12a of the particle feed platform 12 to flatten the surface.

(3) The particle feed platform 12 is moved upward by 60 μm, thereby causing the sample 20 to protrude from the apparatus main body 11 at a height of 60 μm above the apparatus main body 11. The build platform 13 is moved downward by 25 μm to create a gap 13a between the build platform 13 and the apparatus main body 11.

(4) The wiper blade 15 is moved from the end of the particle feed platform 12 on the side opposite to the build platform 13 toward the overflow-particle collection cup 14 at a speed of 75 mm/s. As a result, the sample 20 protruding from the apparatus main body 11 is scraped off, the scraped sample 20 is moved onto the build platform 13, a part of the sample 20 is spread over (recoated on) the gap 13a of the build platform 13, and the remaining sample 20 is moved to the overflow-particle collection cup 14. The overflow-particle collection cup 14 collects the remaining sample 20 that has not been spread over the gap 13a of the build platform 13.

(5) The position of the wiper blade 15 is returned to the end of the particle feed platform 12 on the side opposite to the build platform 13.

(6) The operations (3) to (5) set forth above are continued until the sample 20 filled in the gap 12a of the particle feed platform 12 is used up.

(7) One gram sample is collected out of the sample 20 spread over the gap 13a of the build platform 13, and the collected sample 20 is observed with SEM.

The adhesion evaluation test is repeated 5 times. In the second and subsequent evaluation tests, those that have been collected by the overflow-particle collection cup 14 in the respective previous evaluation test are used as the sample 20.

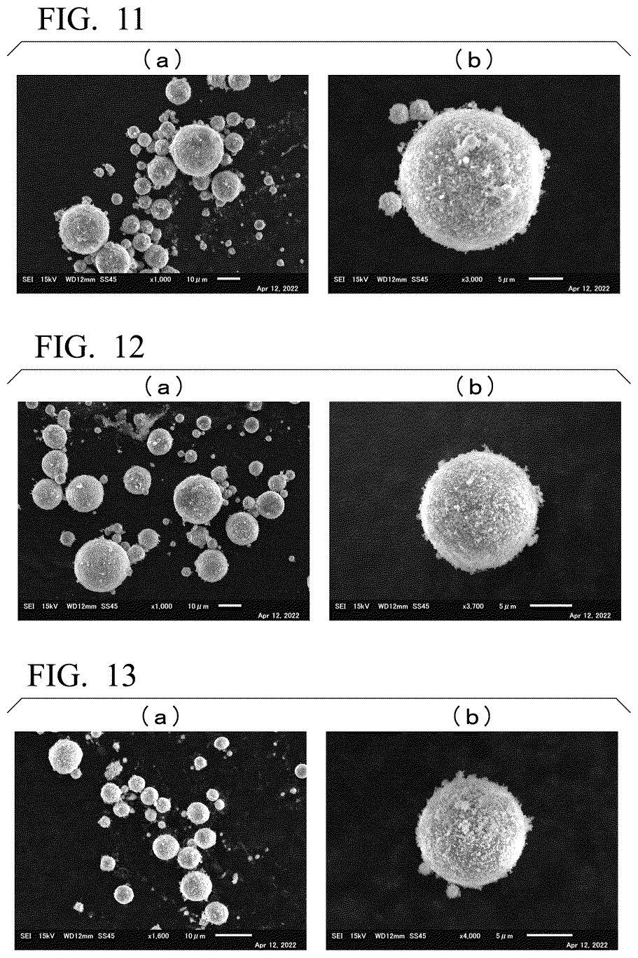

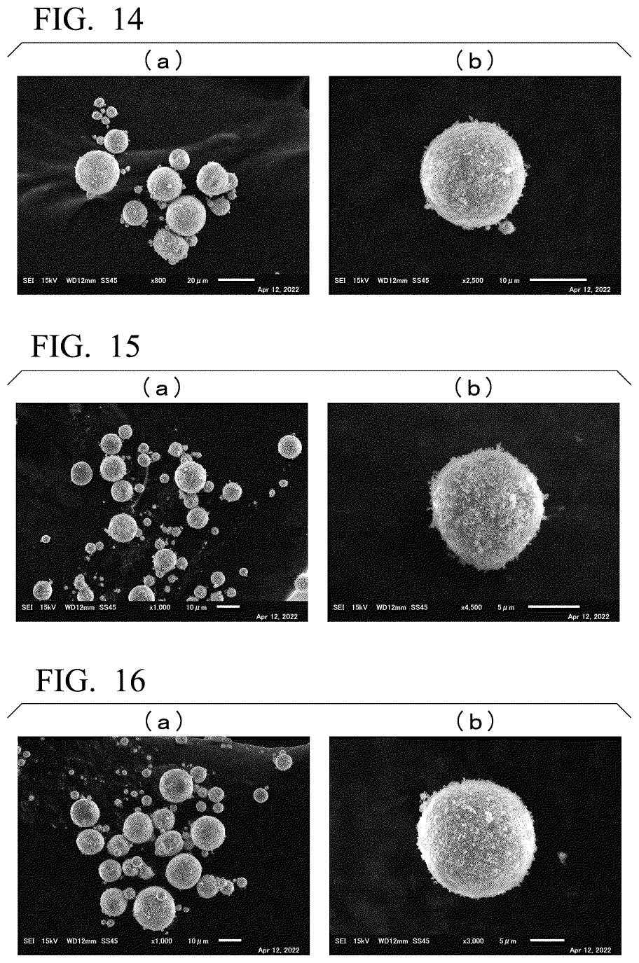

FIG. 11(a) is an SEM image of the zirconia/Ti6Al4V composite particles before the adhesion evaluation test, and FIG. 11(b) is an enlarged SEM image thereof. FIGS. 12 to 16(a) are SEM images of the zirconia/Ti6Al4V composite particles after the adhesion evaluation test, and FIGS. 12 to 16(b) are enlarged SEM images thereof. FIGS. 12, 13, 14, 15 and 16 are SEM images after the first, second, third, fourth and fifth adhesion evaluation tests, respectively. From the comparison between the SEM image of FIG. 11 and the SEM images of FIGS. 12 to 16, no significant changes before and after the adhesion evaluation test were observed in the surface states of the zirconia/Ti6Al4V composite particles. It was confirmed from these results that the zirconia/Ti6Al4V composite particles produced by the method according to the present invention had high adhesion between the zirconia particles and the Ti6Al4V particles, and that the zirconia particles were less likely to fall off when recoating is carried out with the wiper blade 15 (wiper blade for a laser additive manufacturing apparatus).

### Example 6

Except that the concentrations of zirconia particles in the aqueous dispersion and the concentrations of Ti6Al4V particles in the aqueous dispersion were each changed to 1 mass %, the same procedure as in Example 3 was carried out to produce 100 g of zirconia/Ti6Al4V composite particles.

### Example 7

Except that the concentrations of zirconia particles in the aqueous dispersion and of the concentrations of Ti6Al4V particles in the aqueous dispersion were each changed to 5 mass %, the same procedure as in Example 3 was carried out to produce 100 g of zirconia/Ti6Al4V composite particles.

### (Circularity Measurement)

The circularity of the Ti6Al4V particles in the resultant zirconia/Ti6Al4V composite particles was measured. For the circularity measurement, an optical microscope (BX51, available from OLYMPUS Inc.) and analysis software (WinROOF V6.5, available from MITANI SANGYO Co., Ltd.) were used. The circularity C of each particle was calculated from the following equation according to the international standard ISO 9276-6.

$$C = 4 π A / {P}^{2}$$

Where A is the area of the particle (the number of pixels) and P is the perimeter.

The circularity is an average value of the circularities C calculated from freely chosen 200 particles.

Note that, the circularity of the Ti6Al4V particles in the alumina/Ti6Al4V composite particles obtained in Example 1, the circularity of the Ti6Al4V particles in the zirconia/Ti6Al4V composite particles obtained in Example 3, and the circularity of the Ti6Al4V free particles as a reference example were each calculated by the same method as in Examples 6 and 7. The results are shown in Table 2.

TABLE 2

| | | | Concentration of | Concentration of | | | |
|---|---|---|---|---|---|---|---|
| | | Concentration of | Al₂O₃ particles | Ti6Al4V particles | ZrO₂ | Al₂O₃ | |
| | | ZrO₂ particles in | in aqueous | in aqueous | powder | powder | Circularity of |
| | | aqueous dispersion | dispersion | dispersion | content | content | Ti6Al4V |
| | Composite particles | (mass %) | (mass %) | (mass %) | (mass %) | (mass %) | particles (—) |
| Example 1 | Al₂O₃/Ti-6Al-4V | — | 5 | 5 | — | 4.9 | 0.92 (±0.04) |
| Example 6 | ZrO₂/Ti-6Al-4V | 1 | — | 1 | 0.96 | — | 0.91 (±0.05) |
| Example 7 | ZrO₂/Ti-6Al-4V | 5 | — | 5 | 4.9 | — | 0.94 (±0.04) |
| Example 3 | ZrO₂/Ti-6Al-4V | 10 | — | 10 | 8.22 | — | 0.92 (±0.04) |
| Reference | Ti-6Al-4V single body | | | | — | — | 0.93 (±0.04) |
| Example | | | | | | | |

It has been confirmed from the results of Table 2 that in Example 1, the alumina/Ti6Al4V composite particles has a circularity within a range from 0.88 to 0.96, the difference thereof from the circularity (0.89 to 0.97) of the Ti6Al4V free particles is small, and a decrease in the circularity can be suppressed. Similarly, it has been confirmed that in Examples 3, 6 and 7 the circularity of the zirconia/Ti6Al4V composite particles is within a range from 0.86 to 0.98, the difference thereof from the circularity of the Ti6Al4V free particles is small, and a decrease in the circularity can be suppressed.

### (Mechanical Strength Measurement)

The zirconia/Ti6Al4V composite particles obtained in Example 6 were used to produce an additive manufacturing part through a laser three-dimensional powder additive manufacturing method (L-PBF). An additive manufacturing apparatus (MlabR, available from Concept Laser) equipped with a 1070 nm-wavelength Yb fiber laser was used for this manufacturing. Fabrication conditions were a laser output of 95 W, a scanning speed of 800 mm·s⁻¹, a hatch width of 90 μm, and a lamination thickness of 25 μm. The L-PBF production part was a rectangular parallelepiped having a breadth of 6 mm, a length of 30 mm, and a height of 6 mm. The L-PBF process was performed in an argon (Ar) gas atmosphere, and the oxygen concentration was maintained at 0.1 mass % or less.

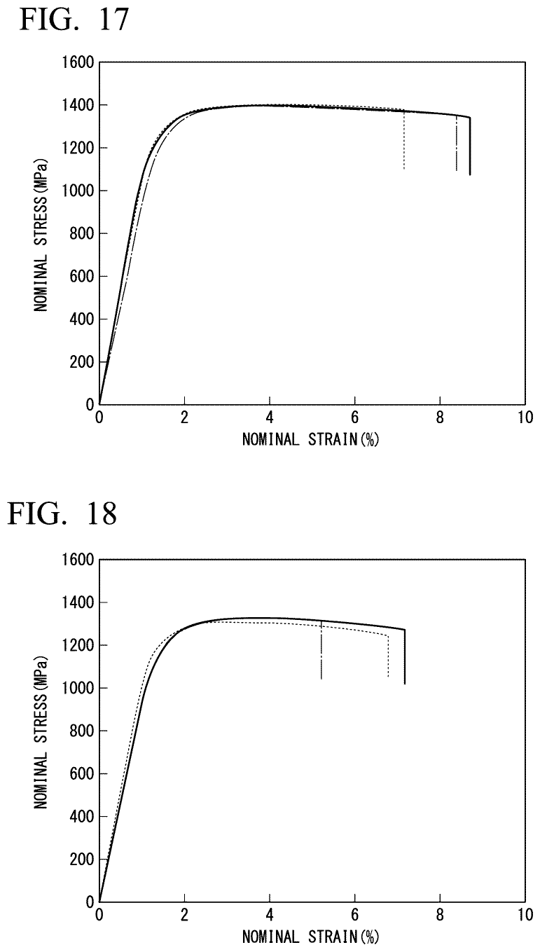

The mechanical strength of the resultant L-PBF production part was measured by a tensile test. A dumbbell-shaped test piece was cut out from the L-PBF production part, and this test piece was used to give a stress-strain plot. As a reference example, Ti6Al4V free particles were melted and solidified by a laser powder bed fusion method (L-PBF) to afford an L-PBF production part, and a test piece cut out by the same method as described above was used to give a nominal stress-nominal strain plot. These results are shown in FIGS. 17 and 18.

From the results in FIG. 17, when the zirconia/Ti6Al4V composite particles were used, the tensile strength was found to be 1210 MPa (±16 MPa), the yield point was found to be 1397 MPa (±3 MPa), and the elongation was found to be 8.1% (±0.7%). On the other hand, from the results in FIG. 18, when the Ti6Al4V particles single body were used, the tensile strength was found to be 1167 MPa (±2 MPa), the yield point was found to be 1312 MPa (±9 MPa), and the elongation was found to be 6.4% (±0.8%). It has been confirmed from this that a compact formed by using the zirconia/Ti6Al4V composite particles was excellent in all of the tensile strength, the yield point, and the elongation as compared with a compact formed by using the Ti6Al4V free particles.

### REFERENCE SIGNS LIST

1 First particles
2 Second particles
3 Ultrafine bubbles
4 Ultrafine bubble-containing dispersion liquid
10 Powder bed quality evaluation apparatus for additive manufacturing
11 Apparatus main body
12 Particle feed platform
12a Gap
13 Build platform
13a Gap
14 Overflow-particle collection cup
15 Wiper blade
20 Sample

1. A method for producing composite particles, the method comprising mixing first particles that are positively charged in water and second particles that are positively charged in water and have an average particle size smaller than that of the first particles in an aqueous medium in the presence of ultrafine bubbles, thereby depositing the second particles on surfaces of the first particles to produce composite particles.

2. The method for producing composite particles according to claim 1, wherein a ratio of the average particle size of the second particles to the average particle size of the first particles is within a range of 1/10000 or more and 1/10 or less.

3. The method for producing composite particles according to claim 1, wherein the average particle size of the first particles is within a range of 1 μm or more and 1000 μm or less.

4. The method for producing composite particles according to claim 1, wherein the average particle size of the second particles is within a range of 1 nm or more and 500 nm or less.

5. Composite particles produced by the production method described in claim 1, wherein
the second particles are contained in an amount within a range of 0.2 mass % or more and 20 mass % or less based on a total mass of the composite particles, and
the first particles have a circularity within a range of 0.8 or more and 0.99 or less.

6. The composite particles according to claim 5, wherein
the second particles are contained in an amount within a range of 0.2 mass % or more and 10 mass % or less based on the total mass of the composite particles.

7. The composite particles according to claim 5, wherein
the circularity of the first particles is within a range of 0.85 or more and 0.99 or less.

8. The composite particles according to claim 5, wherein
the first particles are made of a titanium-aluminum-vanadium alloy, and
the second particles are made of alumina or zirconia.
